(19) United States
(12) Patent Application Publication
(10) Pub. No.: US 2008/0066634 A1
(43) Pub. Date: Mar. 20, 2008

(54) MICROCONTACT PRINTING DEVICE

(75) Inventors: Robert C. Haushalter, Los Gatos, CA (US); Srinivas Vetcha, Sunnyvale, CA (US)

Correspondence Address: DUANE MORRIS LLP, PO BOX 5203, PRINCETON, NJ, 08543-5203, US

(73) Assignee: Parallel Synthesis Technologies, Santa Clara, CA (US)

(21) Appl. No.: 11/860,312

(22) Filed: Sep. 24, 2007

Related U.S. Application Data
(60) Provisional application No. 60/846,614, filed on Sep. 22, 2006.

(51) Int. Cl. B41L 27/00; G01D 15/00

(52) U.S. Cl. 101/124; 216/27

(57) ABSTRACT

A microcontact printing device including a tube member for storing or transferring a printing fluid or liquid and a printing element attached to an end of the fluid dispensing member. Further, a microcontact printhead device including a holder and at least one microcontact printing device disposed within the holder, the microcontact printing device including a tube member for storing or transferring a printing fluid or liquid and a printing element attached to an end of the fluid dispensing member. In addition, a method of fabricating a microcontact printing device including providing a wafer or substrate, micromachining a printing element from the wafer or substrate, providing a tube member for storing or transferring a printing fluid or liquid, and attaching the printing element to an end of the tube member.

### RELATED APPLICATIONS

This Application claims the benefit of U.S. Provisional Patent Application No. 60/846,614 filed Sep. 22, 2006, the entire disclosure of which is incorporated by reference.

This Application is related to U.S. patent application Ser. No. 10/220,913, entitled MICROFABRICATED SPOTTING APPARATUS FOR PRODUCING LOW COST MICROARRAYS, now U.S. patent application publication no. 20030166263; and U.S. patent application Ser. No. 10/795,188, entitled MICROCONTACT PRINTHEAD DEVICE, now U.S. Patent Application Publication No. 20040233250, the entire disclosures of which are incorporated herein by reference.

### FIELD OF THE INVENTION

The present invention relates to printing devices, and more particularly, to a microcontact printing device and a microcontact printhead containing one or more of the microcontact printing devices.

### BACKGROUND OF THE INVENTION

The microarray format for preparing samples of biological materials is the primary method used for monitoring gene expression and several other important biological parameters. In current microarray formats, arrays of approximately 500 nm -200 μm spots of DNA, RNA, proteins or other biological samples are deposited onto a glass substrate using microcontact printing devices including sharpened stainless steel needles or pins. In a typical experiment, between 4 and 64 of the steel pins are dipped into wells of a source plate each well of which contains a different DNA sample, and then touched to the substrate to deposit a spot of DNA. The spots are subsequently subjected to a hybridization reaction with probe/target DNA samples to determine the relative amounts of various DNA molecules in the sample.

The stainless steel pins are typically fabricated from 1/16″ stainless steel rod stock with the sharp tip and capillary channel-fluid reservoir spark cut one at a time with EDM (electronic discharge machine). This laborious serial process results in a current sales price of the pins from $175-625/pin. Recent additions of laser cut and electropolished pins are similarly priced.

In addition to cost issues, the current technology used to fabricate microarrays has other weaknesses. Variability exists in the DNA deposits due to poor pin-to-pin uniformity of printing tip geometry and the sample volume deposited, which leads to difficulties in analysis and decreased confidence in results. The range of DNA deposit sizes that can be printed is currently limited by current printing tip designs, however, it would be advantageous to fit more deposits into smaller spacing on the glass surface. The current technology wastes precious DNA samples, because only a percentage of the sample imbibed into the pin is actually transferred to the glass surface. The chemical resistance and mechanical strength of the pins is an issue as is the fact that the printing tips tend to wear and deform which leads to variability in deposit characteristics. The printing pressure of the pins is merely controlled by gravity as there is no mechanism for controlling printing pressure. The only way the pins can be filled with a sample is by dipping In addition, the steel pins have a limited uptake volume which is often less than 1 μL.

Accordingly, a microcontact printing device is needed that addresses the problems associated with current microcontact printing devices.

### SUMMARY

According to a first aspect of the disclosure, a microcontact printing device comprising a tube member for storing or transferring a printing fluid or liquid, and a printing element attached to an end of the fluid dispensing member.

According to another aspect of the disclosure, a microcontact printhead device comprising a holder and at least one microcontact printing device disposed within the holder, the microcontact printing device including a tube member for storing or transferring a printing fluid or liquid and a printing element attached to an end of the fluid dispensing member.

According to a further aspect of the disclosure, a method of fabricating a microcontact printing device comprising steps of providing a wafer or substrate, micromachining a printing element from the wafer or substrate, providing a tube member for storing or transferring a printing fluid or liquid, and attaching the printing element to an end of the tube member.

### BRIEF DESCRIPTION OF THE DRAWINGS

FIG. 1 is a perspective view of one embodiment of a microcontact printing device.

FIG. 2 is a rear perspective view of the microcontact printing device.

FIG. 3 is a side exploded view the microcontact printing device.

FIG. 4 is a front perspective view of a printing element.

FIG. 5A is a sectional view of a microcontact the printing device.

FIG. 5B is a sectional view of a printing tip.

FIG. 6 is a perspective view of one embodiment of a microcontact printhead device.

FIG. 7 is a sectional view of a microcontact the printing device as it prints on a substrate S.

FIGS. 8A-8D are sectional views illustrating one embodiment of a method for fabricating a microcontact printing device.

### DETAILED DESCRIPTION OF THE INVENTION

A first aspect of the disclosure is a microcontact printing device. The microcontact printing device is especially useful for printing and manufacturing high quality microarrays of proteins, DNA, RNA, polypeptides, oligonucleotides and microarrays of other biological materials having spot volumes in the range of 10⁻¹⁰ picoliters to 100 nanoliters. The microcontact printing device may also be used for printing and manufacturing high quality microarrays of other matters including, without limitation, solid semiconductor quantum dots or liquid dots containing various functional molecules, such as sensors, organic small molecules, organic polymers, solutions of organic polymers, dyes, inks, adhesives, molten metals, solders, glasses, and ceramic oxides.

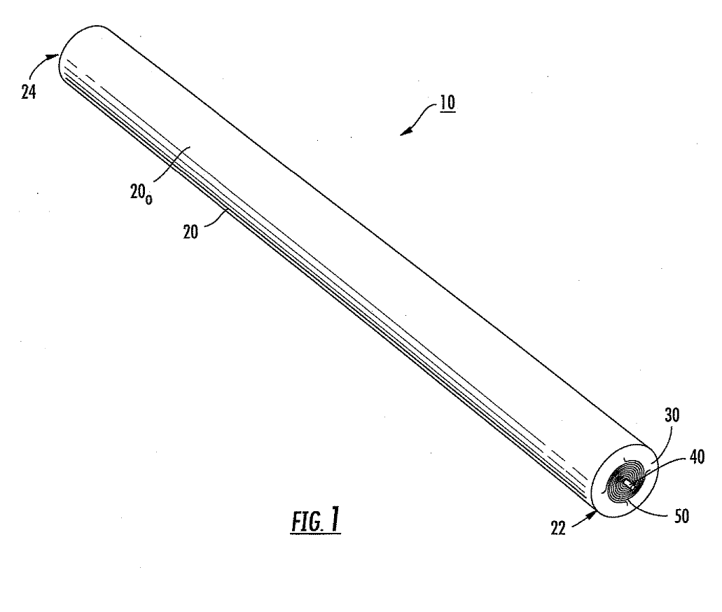

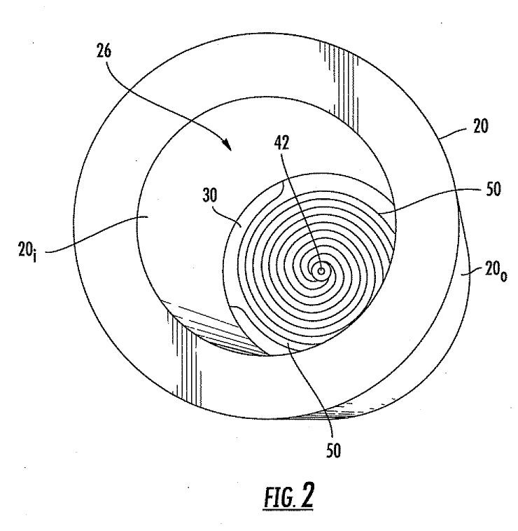

Referring now to the drawings and initially to FIGS. 1-3, there is collectively shown one embodiment of the microcontact printing device, denoted by reference numeral 10. The microcontact printing device 10 generally comprises a tube member 20 defining a fluid conduit 26 and opposing bottom and top open ends 22 and 24 communicating with the fluid conduit 26, and a printing element 30 attached to the bottom open end of the tube member 20. In a preferred embodiment, the printing element 30 is made of silicon, the tube member 20 is made of Pyrex® glass and the silicon printing element 30 is attached to the bottom open end 22 of Pyrex® glass tube member 20 by strong chemical bonds formed in a well known microfabrication technique known in the art as anodic bonding. In other embodiments, the printing element 30, which may be made of silicon or other materials or combination of materials, is attached to the bottom open end 22 of the tube member 20, which may be made of Pyrex® glass or other materials or combination of materials, using other suitable attaching methods including without limitation, adhesive bonding, welding, and soldering methods. In one embodiment, the printing device 10 may have an overall length of about 50 mm. The printing device 10, in other embodiments, may have other overall lengths.

The tube member 20 may be made of any suitable material or combination of materials including, but not limited to, glasses, polymers, metals, metal alloys, ceramics, and silicon. In some embodiments, the tube member 20 may comprise a length of glass or polymer tubing. The glass or polymer tubing may be rigid or flexible, straight or curved. The tube member 20 may include, but is not limited to, round cylindrical outer and inner surfaces 20o and 20i, respectively. It is preferred that the inner surface 20i of the tube member 20 be a round cylindrical surface or some other cylindrical surface shape that avoids sharp corners to provide a smooth flow of a fluid/liquid therethrough, as sharp corners tend to entrain the fluid/liquid and interrupt the fluid flow. Other possible inner cylindrical surface 20i shapes include, without limitation, oval, hexagonal, octagonal, and irregular shapes. The outer cylindrical surface 20o may be other shapes including, without limitation, square, rectangular, oval, hexagonal, octagonal, and irregular shapes. In a preferred embodiment, the tube member 20 comprises a Pyrex® glass tube with round cylindrical outer and inner surfaces 20o and 20i, an outer diameter of about 2 mm, and an inner diameter of about 1 mm. The outer and inner dimensions of the tube member 20 are, of course, not limited to those provided above.

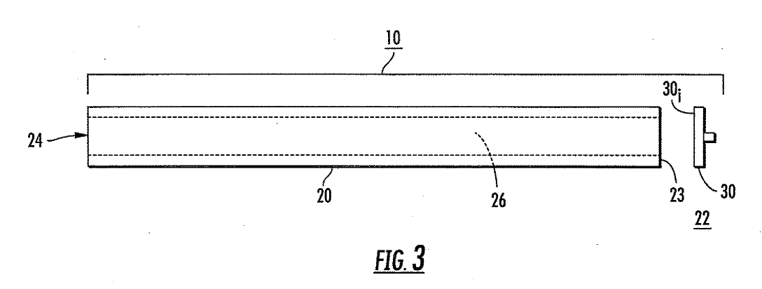

In some embodiments, the fluid conduit 26 of the tube member 20 (best seen in FIG. 3) functions as a fluid/liquid holding reservoir and is constructed with a sufficiently small diameter that enables the tube member 20 to function as a capillary tube to imbibe a fluid/liquid via capillary action into the fluid conduit 26 thereof by immersing the top open end 24 of the tube member 20 into the liquid. In other embodiments, the fluid conduit 26 of the tube member 20 may be filled by immersing the bottom end 22 of the tube member 20 into the liquid which travels through porous regions of the printing element 30 (i.e., one or openings in the printing element 30 to be described further on) and into the fluid conduit 26 thereby filling it by capillary action. In yet other embodiments, the fluid conduit 26 of the tube member 20 may be filled by pressurizing the liquid and forcing it into the fluid conduit 26 via the top open end 24 of the tube member 20. In still other embodiments, the fluid conduit 26 of the tube member 20 may simply function to transfer a fluid/liquid stored in a separate reservoir connected to the tube member 20 (not shown) to the printing element 30. The transfer of the fluid/liquid may be accomplished by capillary action or by pressurizing the liquid and forcing it through the fluid conduit 26, as described above. It should be noted that the fluid/liquid filled conduit 26 is capable of functioning as a convenient storage container for the printing fluid/liquid contained therein, thereby abrogating the need to transfer the printing fluid/liquid out of the printing device for storage.

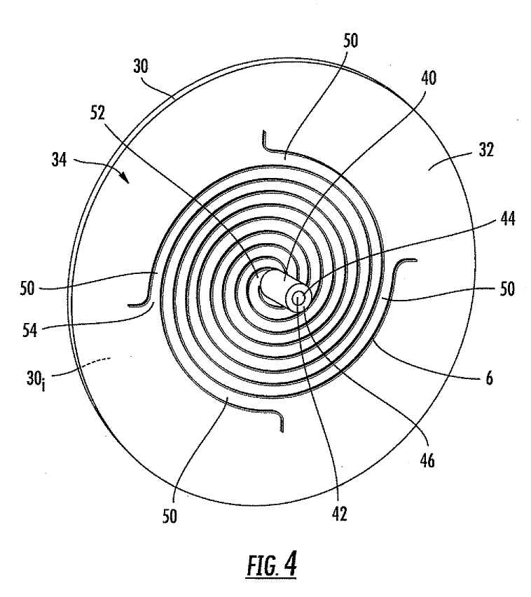

In one embodiment, as shown in FIG. 4, the printing element 30 comprises a perimeter frame 32 and a fluid printing mechanism 34 supported within the perimeter frame 32. The inner surface 30i of the perimeter frame 32 is attached by the bond mentioned earlier, to an outer rim surface 23 of the bottom open end 22 of the tube member 20 (FIG. 3). The fluid printing mechanism 34 includes a printing tip 40 and one or more flexible support members or tethers 50. Each of the tethers 50 has an inner end 52 which is unitary with or attached to the printing tip 40, and an outer end 54 which is unitary with or attached to the perimeter frame 32. The one or more flexible tethers 50 spring-bias the printing tip 40 during printing to provide the printing tip 40 with the requisite compliance and force needed for quality printing. In addition, during a print stroke, capillary forces associated with the fluid conduit 26 and/or the one or more flexible tethers 50, cooperate with capillary forces associated with a printing fluid dispensing channel 42 defined by the printing tip 40 to direct a printing fluid/liquid, contained in or transferred by the fluid conduit 26 of the tube member 20 into the printing fluid dispensing channel 42 of the printing tip 40, as the printing fluid/liquid contained in or delivered by the fluid conduit 26 of the tube member 20 is consumed during the printing process. Also during the print stroke, the printing tip 40 contacts a substrate and dispenses the printing fluid/liquid drawn into the fluid dispensing channel 42 of the printing tip 40 from the fluid conduit 26 of the tube member 20. In other words, the substrates pulls the printing fluid/liquid out of the filled conduit 26, through dispensing channel 42, as the printing element 30 is moved away from the substrate near the end of the print stroke.

In other embodiments, the force and compliance necessary for successful printing is not provided by tethers, but by a continuous membrane whose thickness, flexibility and elasticity are chosen to provide the required degree of compliance (if any) in a direction perpendicular to the plane of the substrate.

In a preferred embodiment, the perimeter frame 32, the printing tip 40 and the one or more tethers 50 of the printing element 30 are formed as a single unitary member. It is also contemplated that one or more of the perimeter frame 32, the printing tip 40 and the one or more tethers 50 of the printing element 30 may be formed separately and then attached to the other components of the printing element 30 using any suitable bonding technique, in alternate embodiments. The printing element 30 with its perimeter frame 32, printing tip 40 and one or more tethers 50, whether unitarily or separately formed, may be made of any material or combination of materials that are suitable for microfabrication including, without limitation, silicon (Si), silicon oxides (SiO₂), germanium (Ge), germanium-silicon (Ge—Si) alloys, silicon carbide (SiC), silicon nitride (Si₃N₄), polymers, ceramics, ferric alloys, and non-ferric alloys. Any suitable microfabrication method or combination of methods may be used for making the components of the printing element 30, depending upon the material or materials selected therefor, the desired dimensional precision of the printing element 30 and/or the desired manufacturing yield. Suitable microfabrication methods include but are not limited to chemical and physical microfabrication, photolithography, photoresist methods, micro-electromechanical methods, e-beam lithography, and x-ray lithography. Precision machining techniques including, without limitation, EDM, drilling and laser cutting techniques, may be used to supplement the microfabrication methods. The printing element 30 may be micromachined as a single unitary member, as mentioned earlier, from a substrate or wafer made of, but not limited to, a semiconductor, ceramic, glass, a metallic, and polymer materials, using conventional photolithographic, wet etching, and Deep Reactive Ion Etching (DRIE) techniques, as will be explained further on. The DRIE process allows hundreds or thousands of individual printing elements 30 to be formed in bulk from a single wafer or substrate. One or more of the individual components of the printing element 30 may also be formed from one or more of the earlier mentioned substrates or wafers or combination of substrates or wafers.

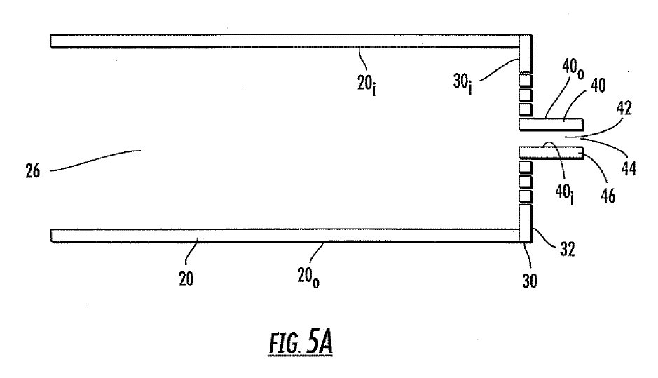

Referring to FIG. 5A, the printing tip 40, in one embodiment, may be formed as a small, tube having, but not limited to, round cylindrical outer and inner surfaces 40o and 40i, respectively. Preferably, the inner surface 40i of the printing tip 40 is a round cylindrical surface or some other cylindrical surface shape that avoids sharp corners to provide a smooth flow of a fluid/liquid therethrough, as sharp corners tend to entrain the fluid/liquid and interrupt the fluid flow. Other possible inner cylindrical surface 40i shapes include, without limitation, oval, hexagonal, octagonal, and irregular cylindrical surface shapes. The outer cylindrical surface 40o of the printing tip 40 may be other shapes including, without limitation, square, rectangular, oval, elliptical, hexagonal, octagonal, and irregular cylindrical shapes.

The fluid dispensing channel 42 extends longitudinally through the printing tip 40 and communicates with the fluid conduit 26 of the tube member 20 at the bottom end 22 thereof. A fluid/liquid outlet 44 is defined by the fluid dispensing channel 42 at a free end of the printing tip 40. The free end of the print tip 40 also defines a rim surface 46 that contacts a substrate to be printed on during printing. In some embodiments, the rim surface 46 may be a substantially flat surface. In other embodiments, the rim surface 46 may be a concave or convex surface. The surface finish of the rim surface 46 may be smooth, textured or undulating. The rim surface 46 in some embodiments may be oriented generally perpendicular to the axis of the fluid dispensing channel 42. In still other embodiments, the rim surface 46 may be formed by multiple surfaces disposed at various angles to the fluid dispensing channel 42.

Referring to FIG. 5B, in order to print properly and consume all the printing fluid/liquid in the fluid conduit 26 of the tube member 20, the aspect ratio of the length L and the inner dimension ID of the fluid dispensing channel 42 (inner diameter ID in embodiments which have the round cylindrical shape fluid dispensing channel 42), must be set so that an effective capillary force draws the printing fluid/liquid into the fluid dispensing channel 42 from the fluid conduit 26 of the tube member 20. Without the capillary forces, an actuator such as, but not limited to, a piezoelectric inkjet or a solenoid actuated syringe device must to used to fill or refill the fluid dispensing channel 42 of the printing tip 40. In one embodiment, assuming the printing fluid/liquid is water and the fluid dispensing channel 42 of the printing tip 40 has a round cylindrical shape, the inner diameter ID of the fluid dispensing channel 42 may be less than 50 microns (μ), and preferably about 10-20μ, and the corresponding length L of the fluid dispensing channel 42 may range between about 10 nanometers (nm) to about 10.0 millimeters (mm), and preferably between about 50μ and about 1000μ, in order to maintain printing tip end surface wetness by capillary action. If the inner dimension or diameter ID and length L of the fluid dispensing channel 42 are incorrectly selected, the printing fluid/liquid may retreat back into the fluid conduit 26 upon depletion due to insufficient capillary attraction into the fluid dispensing channel 42 of the printing tip 40. The capillary forces used for directing the printing fluid/liquid into the fluid dispensing channel 42 of the printing tip 40 may be increased by tapering the fluid dispensing channel 42 so that it defines a frustoconically shaped cylindrical shape with the narrowed end (tapered end) disposed at the outlet 44 of the printing tip 40. If the printing fluid/liquid wets the surface of the printing device or tool, as is the case herein, then the liquid is drawn toward the tapered end of the fluid dispensing channel 42 as it is depleted from the fluid/liquid filled fluid conduit 26.

When the rim surface 46 of the printing tip 40 contacts the substrate during printing, a small amount of the printing fluid/liquid is dispensed onto the substrate in a manner similar to that of a quill or a fountain pen, i.e., the substrate removes the fluid/liquid from the fluid/liquid filled fluid conduit 26 of the printing device 10.

Referring again to FIG. 4, the one or more flexible tethers 50 may comprise, but are not limited to, four, thin, spiral-shape flexible tethers 50 which are equally spaced from one another. In other embodiments, the one or more flexible tethers 50 may be formed in other shapes and numbers, with equal or unequal spacings. The flexible tethers 50 have four functions: (i) to provide the mechanical connection of the printing tip 40 to the perimeter frame 20; (ii) to fluid/liquid seal the fluid conduit 26 at the bottom end of the tube member 20 (the close spacing or gap between the one or more flexible tethers 50, which can range from about 10 nm to about 100 μm, prevents the aqueous printing fluid/liquid contained in the fluid conduit 26 from passing between them); (iii) to direct the flow of the printing fluid/liquid from the fluid conduit 26 of the tube member 20 to the fluid dispensing channel 42 of the printing tip 40; and (iv) to substantially prevent lateral deflection of the printing tip 40 during the printing operation, i.e. allow only vertical or z direction motion of the printing tip 40 (by forming the flexible tethers 50 in a sufficient thickness).

If the one or more flexible tethers 50 are too thin, the printing tip 40 may sag, have insufficient mechanical stability, possess increased lateral motion when the printing tip 40 contacts the substrate and/or be subject to low frequency resonant modes. If the flexible tethers 50 are too thick, the printing tip 40 will not be able to deflect over the large required vertical/z displacement, which in one embodiment may be about 200μ of vertical/z displacement, without breakage. In some embodiments, to avoid breakage of the printing element 30 when the printing tip 40 is forced into the substrate along the z direction, the printing element 30 should be sufficiently flexible to allow the printing tip 40 and the one or more flexible tethers 50 to deflect completely up into the fluid conduit 26 of the tube member 20. In one embodiment, each of the four tethers 50 may have a thickness or height of about 30μ and a median width W of about 70μ. The vertical/z displacement requirement, e.g., 200μ of deflection, is very demanding given the lateral area of the printing element 30. The spiral-shape of the flexible one or more tethers 50 increases their effective length and thus, allows the stress of the deflection to be spread out over a longer distance. Although most substrates are locally flat to within 2-10μ, variations in z, over very large platters (up to about 1 meter²) which deliver the slides under the microcontact printhead device in a typical microarray printing station, can be easily this large.

In other embodiments where breakage may not be of a concern or a problem, the tethers 50 may be made substantially rigid.

The one or more tethers 50 are also constructed in a manner that utilizes capillary forces to direct the printing fluid/liquid into the fluid dispensing channel 42 of the printing tip 40 during printing. This may be accomplished by progressively decreasing the gap G (FIG. 4) between adjacent tethers 50 (or between adjacent portions of the same tether if, for example, only one tether is utilized) as they extend toward the printing tip 40 from the perimeter frame 20. This may be accomplished in one embodiment by progressively increasing the width of the tethers 50 as they extend from the perimeter frame 20 toward the printing tip 40. As the printing fluid/liquid is consumed, the narrower portions of the variably changing gaps retain the printing fluid/liquid longer than the wider portions of the gaps, and therefore the printing fluid/liquid is drawn toward the printing tip 40 and into the fluid dispensing channel 42 thereof.

In an alternative embodiment, the one or more tethers may also be of a constant width and provided with lateral, interdigital texturing, as described and shown in U.S. patent application Ser. No. 10/795,188, entitled MICROCONTACT PRINTHEAD DEVICE, now U.S. Patent Application Publication No. 20040233250, which is incorporated herein by reference. The lateral, interdigital texturing is provided on both sides of each tether on the portion of the tether closest to the printing tip. Moving further away from the printing tip, the lateral, interdigital texturing is provided only on the side of the tether facing towards the printing tip. The portions of the tethers most remote from the printing tip are not provided with the lateral, interdigital texturing.

The increased surface area provided by the lateral, interdigital texturing also enables the tethers to utilize capillary forces to direct the printing fluid/liquid into the fluid dispending channel of the printing tip during printing. The increased surface area provided by the lateral, interdigital texturing also prevents the printing fluid/liquid from flowing through the gaps between the one or more tethers or tether portions.

In a preferred embodiment, the printing element 30 including the one or more flexible tethers 50 are fabricated from silicon (a single crystal silicon substrate). In such an embodiment, the one or more flexible tethers 50 of the printing element 30 will virtually never fatigue because of the elastic properties of silicon and the lack of crystal grain boundaries in the single crystal silicon substrate. Unlike metal springs, the one or more silicon flexible tethers 50 will virtually always return the printing tip 30 to the same position and will deflect with the same amount of force during each printing cycle.

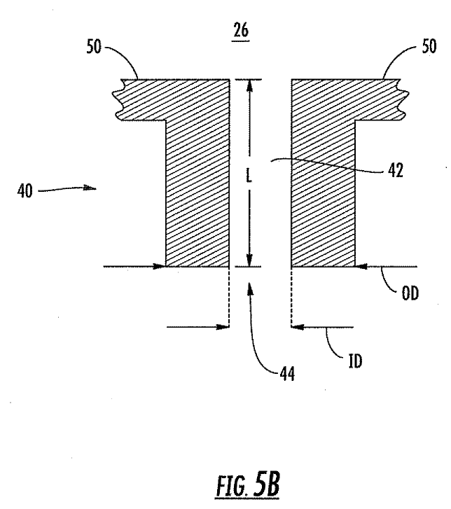

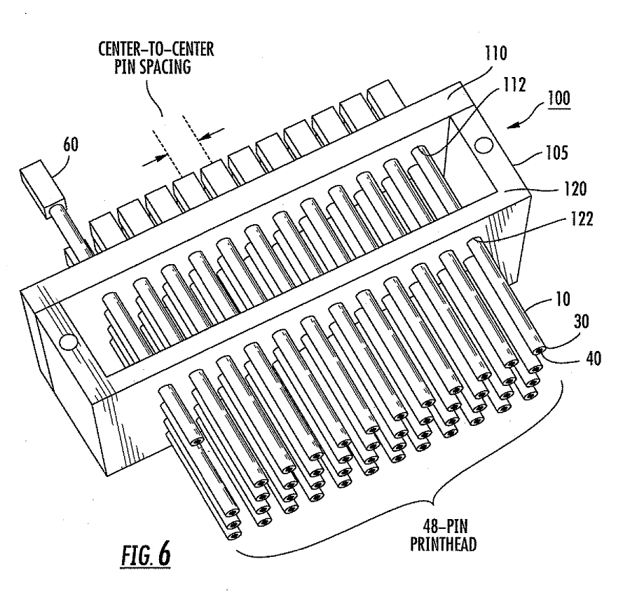

Another aspect of the disclosure is a microcontact printhead device. FIG. 6 shows one embodiment of the microcontact printhead device, denoted by reference numeral 100. The microcontact printhead device 100 comprises a pin holder 105 including an upper plate member 110 and a lower plate member 120 connected to and spaced from the upper plate member 110, and a plurality or an array of microcontact printing devices 10 extending through vertically aligned apertures 112 and 122 in the upper and lower plate members 110 and 120. Each of the microcontact printing devices 10 includes a stop member 60 mounted on the top end of the tube member 20 that suspends the microcontact printing device 10 in the pin holder 110. The microcontact printhead device 100 is capable of printing an array of fluid/liquid spots on a substrate and providing a different printing fluid to each printing tip 40 in the array of printing elements 30 within the printhead 100 without cross contamination.

Another aspect of the present invention is a method of fabricating the microcontact printing device 10. The printing element 30 of the microcontact printing device is preferably made from silicon using silicon micromachining methods. Silicon micromachining refers to the selective removal of defined regions of silicon or masking material, on the length scales of millimeters to nanometers, from a silicon substrate by an etching process. Etching is the primary means by which the third dimension of a micromachined structure is obtained from a planar photolithographic process. In the case of the printing element 30, the perimeter frame, the printing tip 40, the one or more flexible tethers 50 are all three dimensional structures. There are generally two main types of anisotropic etching processes: anisotropic wet etching using hot aqueous KOH and dry/plasma etching techniques such as DRIE. For both etching techniques, the pattern to be etched is defined by a photolithographic process. The silicon substrate from which the printing element 30 will be fabricated is preferably a single crystal silicon wafer, usually with a (100) orientation. The anisotropic wet etching technique involves, after patterned removal of the etch resistant silicon dioxide outer layer, etching at approximately 80° C. in aqueous KOH. Ethylenediamine may also be used as a wet etchant. This chemical etch attacks the silicon <100> planes many times faster than the <111> planes and can be used to etch square pits with approximately 57° <111> sidewalls into (100) silicon wafers. One advantage of the wet etching technique is that many wafers may be inexpensively etched in parallel. A disadvantage of the wet etching technique is that it only cuts along certain crystallographic planes and not at arbitrary angles. The most selective dry etching technique is DRIE, which is noted for its ability to etch very high aspect ratio trenches. This plasma technique rapidly pulses the etchant and passivator gasses alternatively over the substrate. DRIE is capable of cutting a thin approximately 10-20μ wide trench through a 500μ thick wafer with sidewalls vertical to within a few degrees over the depth of the cut. The pattern to be etched is simply defined in photoresist, which etches much more slowly than the silicon, and the etch removes the silicon not protected by the etch-resistant photoresist. An advantage of DRIE is that any arbitrary shape can be cut to very high precision but a potential disadvantage is that only one wafer at a time can be processed.

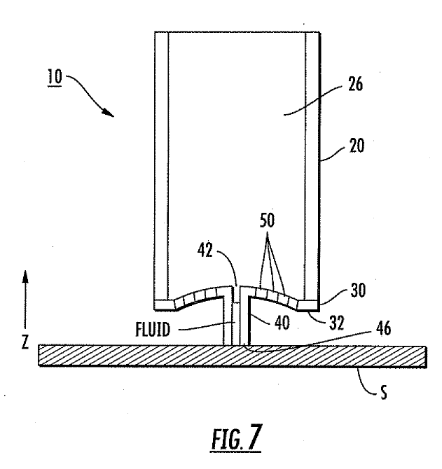

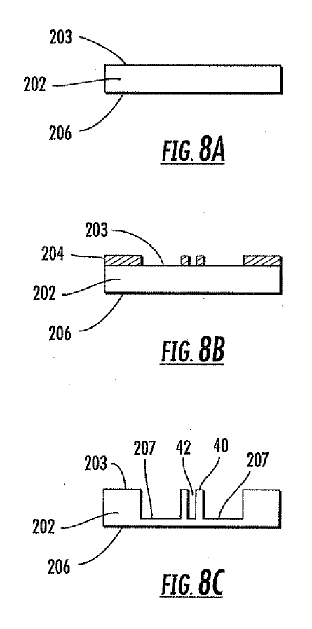

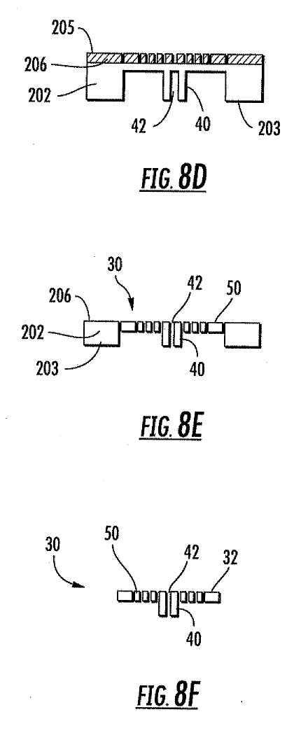

FIGS. 8A-8F collectively show one embodiment of a method for fabricating one or more printing elements (FIGS. 8A-8F only show the fabrication of one printing element). The method commences with the procurement of a wafer 202 having a first surface 203 and an opposing second surface 206, as shown in FIG. 8A. In a preferred embodiment, the wafer 202 is a single crystal silicon wafer with a (100) orientation. In a first mask pattern 204 is photolithographically formed on the first surface 203 of the wafer 202, as shown in FIG. 8B. The first mask pattern 204 will be used for defining the outer profile of the printing tip(s) 40 and a portion of the fluid dispensing channel(s) 42, and thinning the area of the wafer 202 where the one or more tethers 50 and the perimeter frame 32 of the printing element(s) 30 will be formed.

As shown in FIG. 8C, unmasked portions of the first surface 203 of the wafer 202 are etched using DRIE to define the outer profile of the printing tip(s) 40 and a portion of the fluid dispensing channel(s) 42 of the printing element(s) 30. The DRIE also thins the area 207 of the wafer 202 where the one or more tethers 50 and the perimeter frame 32 of the printing element(s) 30 will be formed.

As shown in FIG. 8D, a second mask pattern 205 is photolithographically formed on the second surface 206 of the wafer 202. The second mask pattern 205 will be used for defining the remaining portion of the fluid dispensing channel(s) 42 and the one or more tethers 50 of the printing element(s) 30.

As shown in FIG. 8E, unmasked portions of the second surface 206 of the wafer 202 are etched using DRIE to define remaining portion of the fluid dispensing channel(s) 42 of the printing tip(s) 40 and the one or more tethers 50.

The wafer 202 may then be thermally oxidized to form a coating of SiO₂ over the printing element(s) 30 (in embodiments where the wafer is made of silicon) and separated from the wafer 200, as shown in FIG. 8F.

The microcontact printing device disclosed herein addresses the deficiencies of conventional steel-based pins. The DRIE process, which may be used for fabricating the printing elements of the printing device, produces cuts approximately 100× more precise and smooth than the techniques used to fabricate conventional steel-based machine shop pins. In addition, the DRIE process allows hundreds of printing elements to be fabricated in parallel, thus, pin-to-pin variation is essentially eliminated as compared to the steel pins. The higher micromachining precision also results in far more uniform printing tip rim surface, which yields more consistently shaped spots and is capable of producing a printing tip rim surface having a printing surface area of between about 5×10⁷ and 10⁻⁶ square micrometers. Further, both the printing device density in the microcontact printhead device disclosed herein and the size of the printing tips can be easily miniaturized. Approximately 20 μm diameter printing tips on about 50 μm to about 125 μm centers or less, may be achieved using the fabrication method disclosed herein. Accordingly a microcontact printhead device having a printing tip or printing element density between about 2 and 10¹² printing tips/elements per square centimeter may be achieved. Because of their construction, it is not possible to pack the conventional steel pins closer than the 4.5 mm spacing of the 384 format. Printing tips/elements on 50 μm centers are approximately 8×10³ denser than the densities of steel pins in conventional holders. Since the printing elements in the preferred embodiment are made of silicon, a thin silicon dioxide (SiO₂) film typically coats the surfaces of the printing elements. The wetting properties, chemical compatibilities and derivatization chemistry of SiO₂ are well known as compared to the Cr₂O₃ surface of conventional stainless steel pins. Moreover, silicon is harder and much more elastic than stainless steel and will therefore wear much more slowly. The microcontact printhead device is also much less costly to manufacture than conventional steel pin microcontact printing devices.

A further aspect of the disclosure is a method of printing a microarray using the microcontact printhead device disclosed herein. In one embodiment of the printing method, a different solution of a sample of a DNA oligonucleotide, for example DNA in 3×SSC buffer, is dispensed into the fluid conduits of the printing devices mounted in the microcontact printhead device using an active fluid transfer device, such as a manual or automated pipetting system, e.g., liquid handling robot or pipette. A substrate is then prepared for printing by coating a flat glass microscope slide with a reagent to immobilize the DNA. The reagent may be polylysine or other protonated surface amino group. The microcontact printing devices of the microcontact printhead device are quickly touched to the substrate surface with a force sufficient to cause each printing tip to deposit a small quantity, including without limitation, 10⁻¹⁰ picoliters to 100 nanoliters, of the DNA printing fluid onto the substrate. The substrate with the DNA microarray of deposited spots may then be used for experiments, such as gene expression monitoring by subjecting the microarray to hybridization reactions.

The printing method, in another embodiment, comprises preparing a droplet array on a surface, using a solution of a sample of a DNA oligonucleotide, for example DNA in 3×SSC buffer, and controlling the atmosphere above the samples so that the samples do not evaporate. The droplet array may be prepared using, for example, an automated liquid dispenser, which places the droplets onto a patterned hydrophobic surface. The hydrophobic surface precludes any lateral movement of the droplet. The microcontact printing devices or the microcontact printhead device are loaded by dipping the printing tips of the printing devices into their corresponding droplets of the droplet array (instead of loading the printing fluid directly into the fluid conduits of the printing devices as in the previous embodiment). A substrate is then prepared for printing by coating a flat glass microscope slide with a reagent to immobilize the DNA. The reagent may be polylysine or other protonated surface amino group. The microcontact devices of the microcontact printhead device are quickly touched to the substrate surface with a force sufficient to cause each printing tip to deposit a small quantity of the DNA printing fluid onto the substrate. The small quantity of the DNA printing fluid deposited on the substrate may range between 10⁻¹⁰ picoliters to 10 nanoliters, 10⁻¹⁰. The substrate with the DNA microarray of deposited spots may then be used for experiments, such as gene expression monitoring by subjecting the microarray to hybridization reactions.

The micromachined microcontact printing devices disclosed herein address many of the shortcomings and needs of conventional microcontact printing devices. It is clear that users of microcontact printing technologies, and the DNA microarray fabrication process itself, can benefit from the precision, rapid prototyping and economy of scale of the microcontact printing devices disclosed herein. In addition, the microcontact printing devices may be readily adapted to existing printing hardware.

While the foregoing invention has been described with reference to the above, various modifications and changes can be made without departing from the spirit of the invention. Accordingly, all such modifications and changes are considered to be within the scope of the appended claims.

What is claimed is:

1. A microcontact printing device comprising:
a tube member for storing or transferring a printing fluid or liquid; and
a printing element attached to an end of the fluid dispensing member.

2. The microcontact printing device according to claim 1, wherein the printing element includes a perimeter frame and a fluid printer disposed within the perimeter frame.

3. The microcontact printing device according to claim 2, wherein the fluid printer includes a printing tip, the printing tip defining a fluid dispensing channel that communicates with the tube member.

4. The microcontact printing device according to claim 3, wherein the fluid dispensing channel is capable of applying a capillary force to the printing fluid or liquid.

5. The microcontact printing device according to claim 3, wherein the fluid printer further includes at least one member attaching the printing tip to the perimeter frame.

6. The microcontact printing device according to claim 5, wherein the at least one member is capable of applying a capillary force to the printing fluid or liquid.

7. The microcontact printing device according to claim 5, wherein the printing element is at least partially made of a material or a combination of materials selected from the group consisting of silicon, silicon carbide, silicon oxides, silicon nitride, germanium, germanium-silicon alloys, polymers, ceramics, and non-ferric alloys.

8. The microcontact printing device according to claim 2, wherein the fluid printer further includes at least one member attached to the perimeter frame.

9. The microcontact printing device according to claim 8, wherein the at least one member is capable of applying a capillary force to the printing fluid or liquid.

10. The microcontact printing device according to claim 1, wherein the printing element includes a spring biased fluid printer.

11. The microcontact printing device according to claim 1, wherein the printing element includes a spring biased printing tip.

12. The microcontact printing device according to claim 1, wherein the tube member includes a fluid conduit, the fluid conduit capable of applying a capillary force to the printing fluid or liquid.

13. The microcontact printing device according to claim 1, wherein the printing element is at least partially made of a material or a combination of materials selected from the group consisting of silicon, silicon carbide, silicon oxides, silicon nitride, germanium, germanium-silicon alloys, polymers, ceramics, and non-ferric alloys.

14. The microcontact printing device according to claim 1, wherein the printing element includes a printing tip having a printing surface area of between about 5×10⁷ and about 10⁻⁶ square micrometers.

15. A microcontact printhead device comprising:
a holder; and
at least one microcontact printing device disposed within the holder, the at least one microcontact printing device comprising:
a tube member for storing or transferring a printing fluid or liquid; and
a printing element attached to an end of the fluid dispensing member.

16. The microcontact printhead device according to claim 15, wherein the printing element includes a perimeter frame and a fluid printer disposed within the perimeter frame.

17. The microcontact printhead device according to claim 15, wherein the printing element includes a spring biased fluid printer.

18. The microcontact printhead device according to claim 15, wherein the printing element includes a spring biased printing tip.

19. The microcontact printhead device according to claim 15, wherein the tube member includes a fluid conduit, the fluid conduit capable of applying a capillary force to the printing fluid or liquid.

20. The microcontact printhead device according to claim 15, wherein the printing element is at least partially made of a material or a combination of materials selected from the group consisting of silicon, silicon carbide, silicon oxides, silicon nitride, germanium, germanium-silicon alloys, polymers, ceramics, and non-ferric alloys.

21. The microcontact printhead device according to claim 15, wherein the at least one printing element is an array of printing elements having a printing tip density between about 2 and about 10¹⁴ printing tips per square centimeter.

22. The microcontact printhead device according to claim 15, wherein the at least one printing element includes a printing tip having a printing surface area of between about 5×10⁷ and about 10⁻⁶ square micrometers.

23. A method of fabricating a microcontact printing device, the method comprising steps of:
providing a wafer or substrate;
micromachining a printing element from the wafer or substrate;
providing a tube member for storing or transferring a printing fluid or liquid; and
attaching the printing element to an end of the tube member.

24. The method according to claim 23, wherein the wafer or substrate is made of a material selected from the group consisting of silicon, silicon carbide, silicon oxides, silicon nitride, germanium, germanium-silicon alloys, polymers, ceramics, and non-ferric alloys.

25. The method according to claim 23, wherein the micromachining step is performed by at least one of wet etching, dry etching, and photolithography.
